(19) United States
(12) Patent Application Publication
(10) Pub. No.: US 2006/0264114 A1
(43) Pub. Date: Nov. 23, 2006

(54) Connector system

(76) Inventors: Donald J. Novotney, San Jose, CA (US); Evans Hankey, San Francisco, CA (US); Stephen Zadesky, San Carlos, CA (US)

Correspondence Address: SAWYER LAW GROUP LLP, P O BOX 51418, PALO ALTO, CA, 94303, US

(21) Appl. No.: 11/488,307

(22) Filed: Jul. 18, 2006

Related U.S. Application Data
(63) Continuation of application No. 11/031,301, filed on Jan. 7, 2005.

(51) Int. Cl. H01R 24/00

(52) U.S. Cl. 439/660

(57) ABSTRACT

A connector is disclosed. The connector comprises a plurality of universal serial bus (USB) pins, and a plurality of pins for additional functionality, wherein the connector can engage a conventional USB connector or a connector that also utilizes the plurality of pins. Accordingly, in the present invention, a male and female connectors are provided that include additional pins within the connector that provide for additional functionality. This is accomplished utilizing the standard interface of the USB connector but adding additional pins around that interface to provide this functionality.

### CROSS-REFERENCE TO RELATED APPLICATIONS

This application is a continuation of U.S. patent application Ser. No. 11/031,801, filed Jan. 1, 2005, entitled “Connector System.”

### FIELD OF THE INVENTION

The present invention relates generally to a connector system and more particularly to a connector system which includes a universal serial bus interface.

### BACKGROUND OF THE INVENTION

Connectors are utilized in a variety of devices. For example, universal serial bus (USB) connectors are utilized in processing systems, PDAs, digital cameras, MP3 players or other types of devices that can receive data from a memory device. It is desirable to have a connector that will interface with a conventional interface standard such as USB. However, it can also be desirable to interface with a connector that includes additional functionality not offered by the particular standard interface being used. For example, the standard USB interface does not provide audio or video input/output signal lines.

### SUMMARY OF THE INVENTION

A connector is disclosed. The connector comprises a plurality of universal serial bus (USB) pins, and a plurality of pins for additional functionality, wherein the connector can engage a conventional USB connector or a connector that also utilizes the plurality of pins.

Accordingly, in the present invention, a male and female connectors are provided that include additional pins within the connector that provide for additional functionality. This is accomplished utilizing the standard interface of the USB connector but adding additional pins around that interface to provide this functionality.

### BRIEF DESCRIPTION OF THE DRAWINGS

FIG. 1 illustrates a conventional female USB connector.

FIG. 2 illustrates a conventional male USB connector.

FIG. 3 illustrates the connector of FIG. 1 and connector of FIG. 2 before mating.

FIG. 4 illustrates the connectors of FIGS. 1 and 2 after they have mated.

FIG. 5 is a front view of the female connector in accordance with the present invention.

FIG. 5A is a perspective view of the female connector of FIG. 5.

FIG. 5B is a drawing illustrating detailed dimensions of a female connector in accordance with the present invention.

FIG. 6 illustrates a front view of a male connector in accordance with the present invention.

FIG. 6A is a drawing illustrating detailed dimensions of a male connector in accordance with the present invention.

FIG. 7 illustrates the connectors of FIGS. 6 and 7 before mating.

FIG. 8 illustrates the connectors of FIGS. 6 and 7 after mating.

FIG. 9 illustrates the connectors of FIGS. 1 and 6 before mating.

FIG. 10 illustrates the connectors of FIGS. 1 and 6 after mating.

FIG. 11 illustrates the connectors of FIGS. 2 and 5 before mating.

FIG. 12 illustrates the connectors of FIGS. 2 and 5 after mating.

FIG. 13 shows an exemplary system using the connector described herein.

### DETAILED DESCRIPTION

The present invention relates generally to a connector system and more particularly to a connector system which includes a universal serial bus interface. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

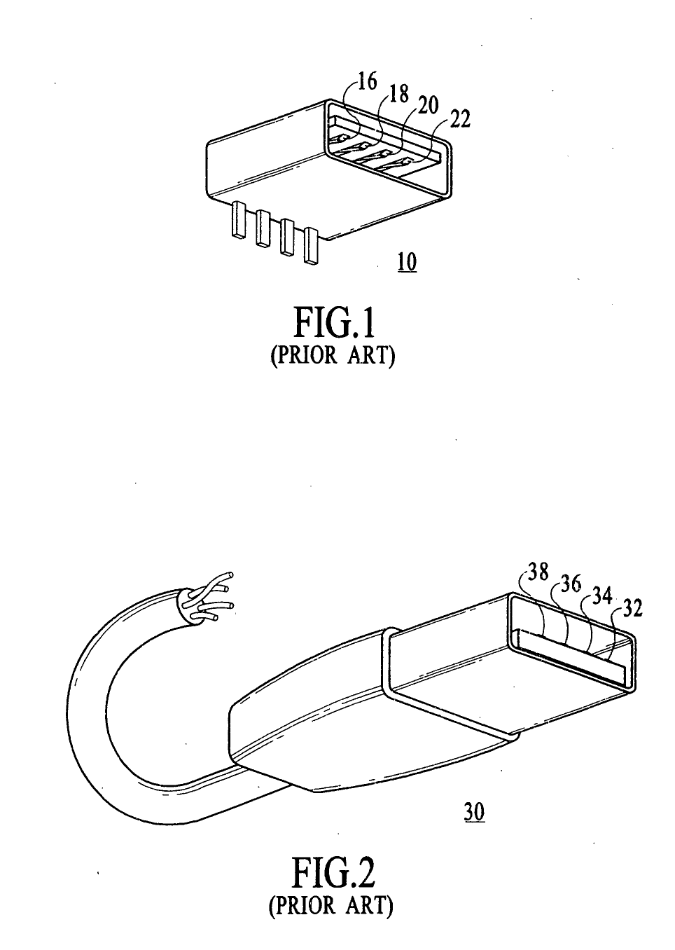

FIG. 1 illustrates a conventional female USB connector 10. The connector 10 includes a housing 14. The housing 14 is typically enclosed within a device such as a computer, PDA, printer, digital camera or other device. The connector 10 as is seen has four pins 16, 18, 20 and 22, for allowing for connections to a male connector.

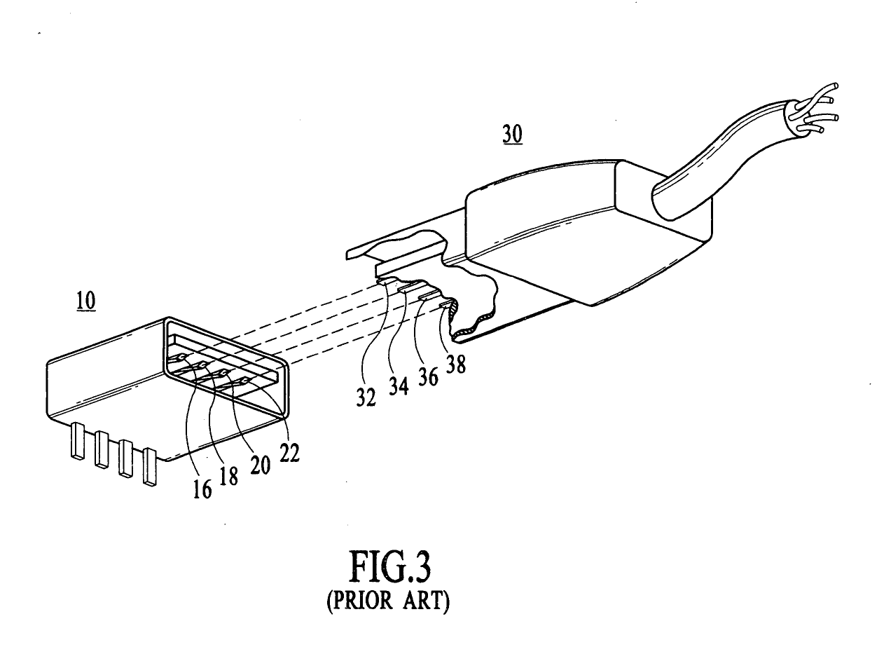

FIG. 2 illustrates a conventional male USB connector 30. The male connector includes a circuit board which includes pins or circuit traces 32, 34, 36 and 38 on a circuit board which connect to the four pins 16-22 of the female connector 10.

FIG. 3 illustrates the connector 10 of FIG. 1 and connector 30 of FIG. 2 before mating. As is seen by the dotted lines, the pins 32-38 of the connector 10 engage the tracings 16-22 of the male connector 30.

FIG. 4 illustrates the conventional USB connectors 10 and 30 after they have mated. It is desirable to provide additional functionality into this type of connector, particularly with a connector that has a standard interface such as a USB interface, while not increasing the overall size of the connector or creating more complexity in the connector or requiring an additional connector.

Accordingly, the present invention provides for a system for addressing the above-identified issues by providing additional signal pins within both the male and female connectors such that they can add additional functionality. The additional functionality could be, for example, video, audio, or other types of functionality to the particular system. For example, it may be desirable in a device such as the Apple iPod to provide such a connector to provide audio or video input/output lines directly to a device to which it is connected, even if no such dedicated IO lines are otherwise available. Accordingly, in the present invention, a male and female connectors are provided that include additional pins within the connector that provide for additional functionality. This is accomplished utilizing the standard interface of the USB connector but adding additional pins around that interface to provide this functionality. To describe the features of the invention in more detail, refer now to the following description in conjunction with the accompanying figures. FIG. 5 is a front view and FIG. 5A is a perspective view of the female connector 100 in accordance with the present invention. As is seen, it includes the same four pins 16′-22′ as the conventional female USB connector 10 of FIG. 1 on plate 103 within housing 105. It also includes five additional pins 102, 104, 106, 108 and 110 which can be used for additional functionality. The additional pins are placed in between the plurality of USB pins such that the USB pins can engage a conventional USB connector. In this particular embodiment, the additional functionality is for a serial data in pin, a serial data out pin, audio right, audio left and audio ground. As is seen, the four pins 16′-22′ satisfy the USB interface standard while five additional pins 102-110 are provided therewithin to add for the additional functionality. As before mentioned, this female connector 100 can then be mated with a male connector that has the complimentary pinout. As illustrated in FIG. 5A, the pins can be spring-loaded to engage the circuit traces of a male connector, but they may be of any conventional construction that accomplishes the mating between the complimentary pins on the male and female connectors. FIG. 5B is a drawing of illustrating detailed dimensions of a female connection in accordance with the present invention.

Table 1 below illustrates the specific pin out for the female connection 100. As is seen, USB pin 1 (pin 16′) is a power pin, USB pin 2 (pin 18′) is a data−pin, USB pin 3 (pin 20′) is a data+pin, and USB pin 4 (pin 22′) is a ground pin. As is further seen, additional pin 5 (pin 102) is a serial data to device pin, additional pin 6 (pin 104) is a serial data from device pin, additional pin 7 (pin 106) is an audio common pin, additional pin 8 (108) is an audio left pin and additional pin 9 (pin 110) is an audio right pin.

TABLE 1

| PIN NUMBER | SIGNAL |
|---|---|
| 1 (Pin 16′) | +5 V |
| 2 (Pin 18′) | Data− |
| 3 (Pin 20′) | Data+ |
| 4 (Pin 22′) | Ground |
| 5 (Pin 102) | Serial data to device |
| 6 (Pin 104) | Serial data from device |
| 7 (Pin 106) | Audio common |
| 8 (Pin 108) | Audio left |
| 9 (Pin 110) | Audio right |

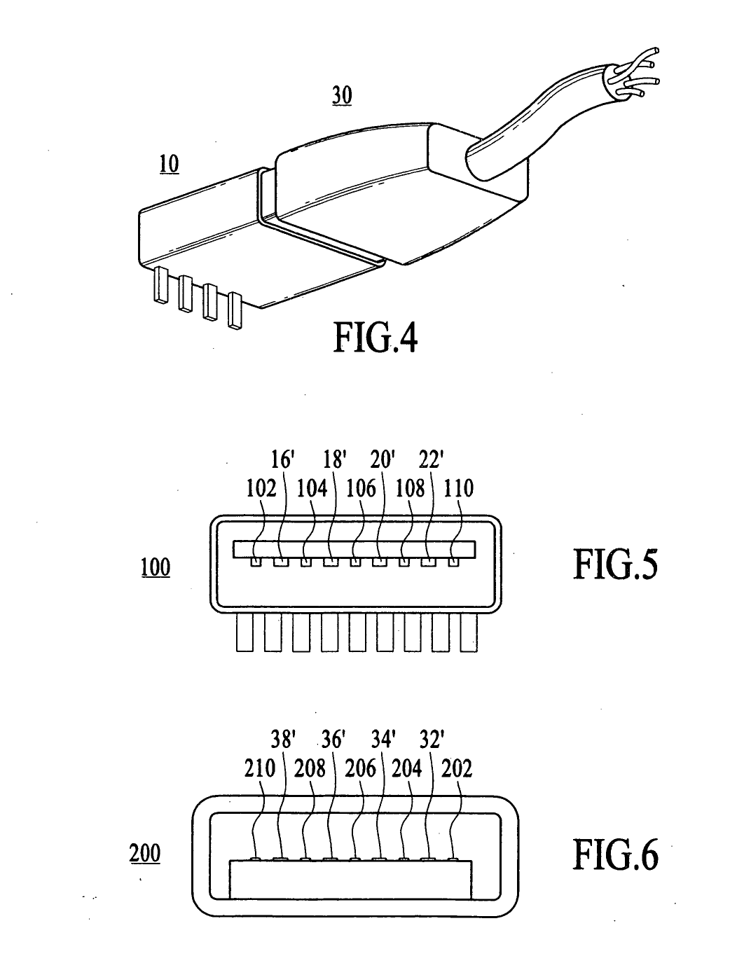

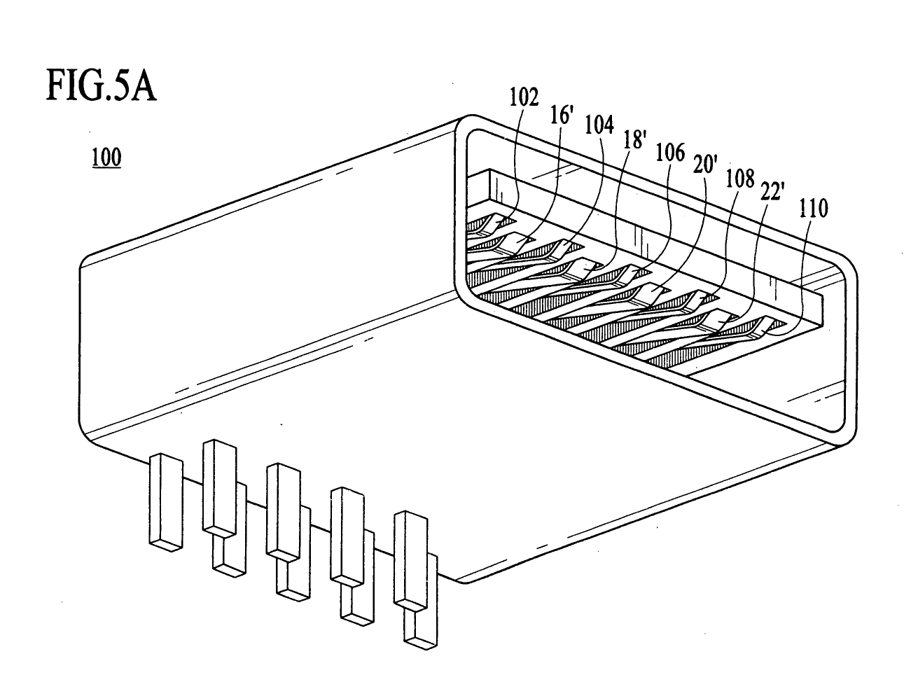

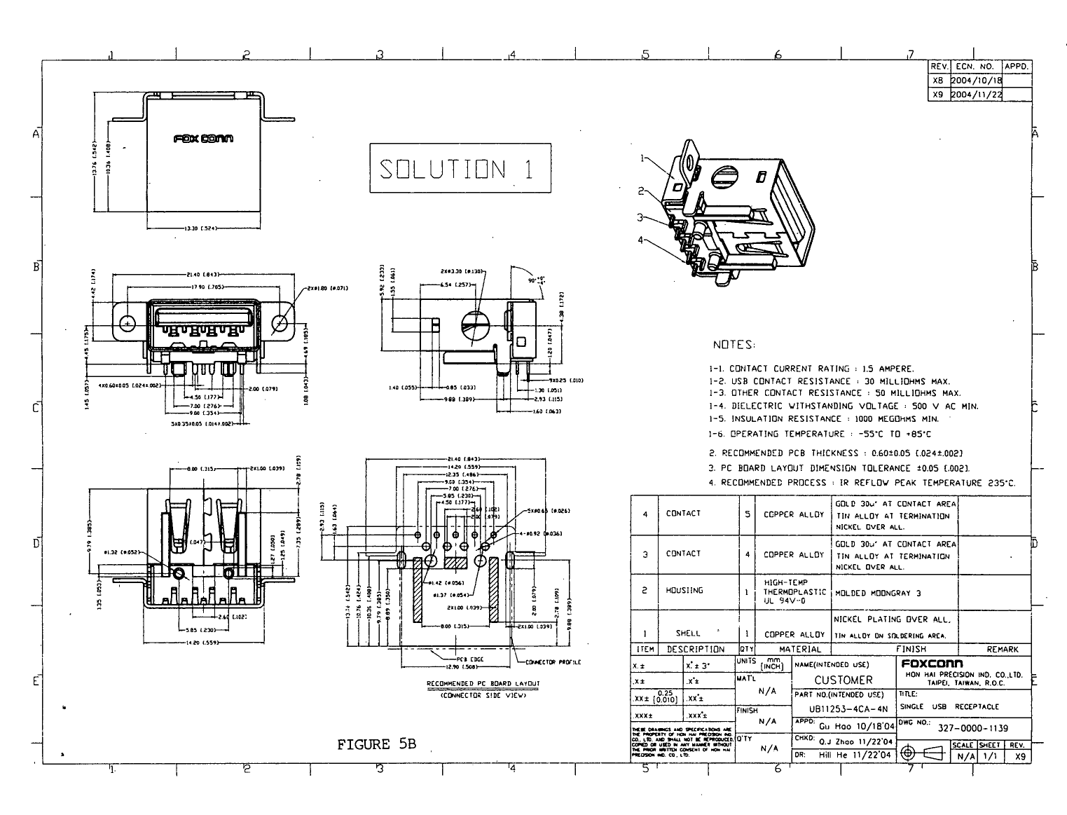

FIG. 6 illustrates a front view of a male connector 200 in accordance with the present invention. The male connector 200 as seen has the identical four circuit traces, 32′, 34′, 36′ and 38′ as shown in the conventional USB male connector 30 of FIG. 2, but it also includes the additional functionality of five additional circuit traces, 202, 204, 206, 208 and 210 on circuit board 203 within housing 205. In so doing, a female connector 100 of FIG. 5 can be mated with the male connector 200 to provide the additional functionality. FIG. 6A is a drawing illustrating detailed dimensions of a male connector in accordance with the present invention.

A key feature of the present invention is that both of these connectors can be utilized with the conventional USB connectors. To illustrate this feature, refer now to the following description in conjunction with the accompanying figures.

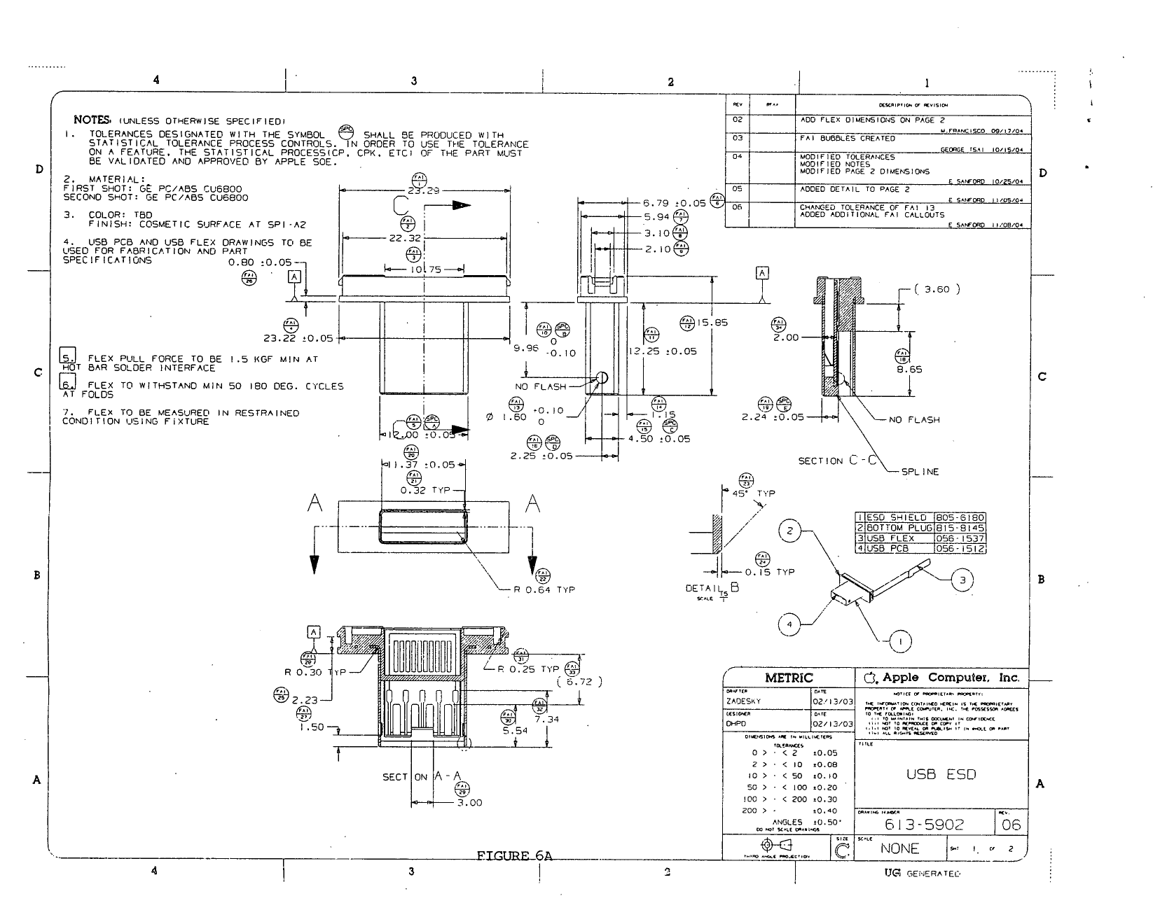

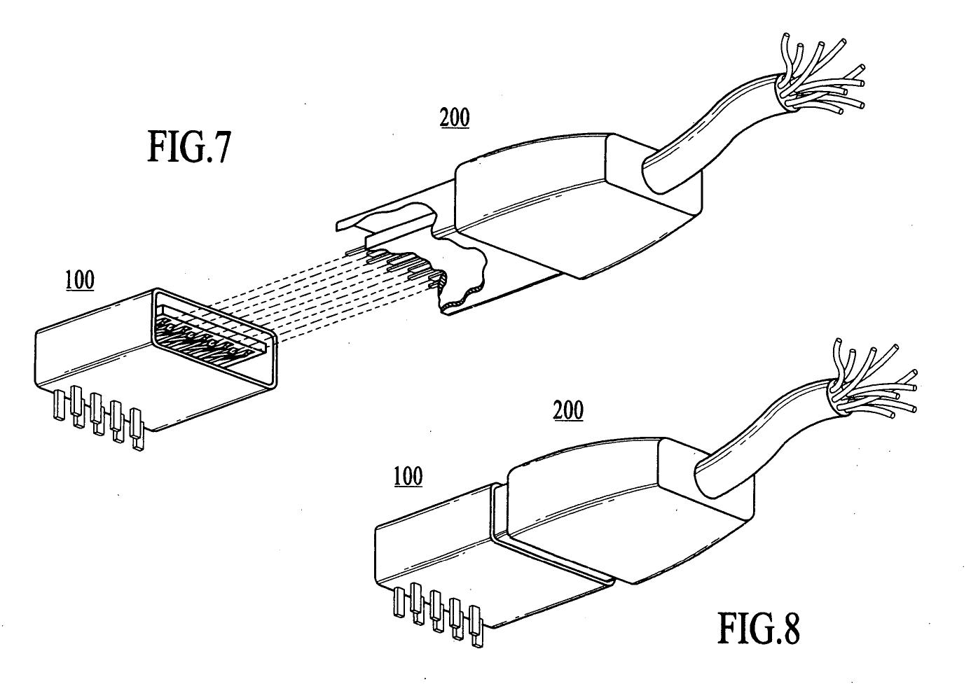

Referring now to FIG. 7, what is shown is the male connector 200 of FIG. 6 mating with the female connector 100 of FIG. 5. In this embodiment, as is seen, the four pins from the male connector 200 can engage the appropriate four USB connector pins of the female connector 100, and the USB connection will operate in an effective manner. FIG. 8 illustrates the connectors 100 and 200 of FIGS. 6 and 7 after mating.

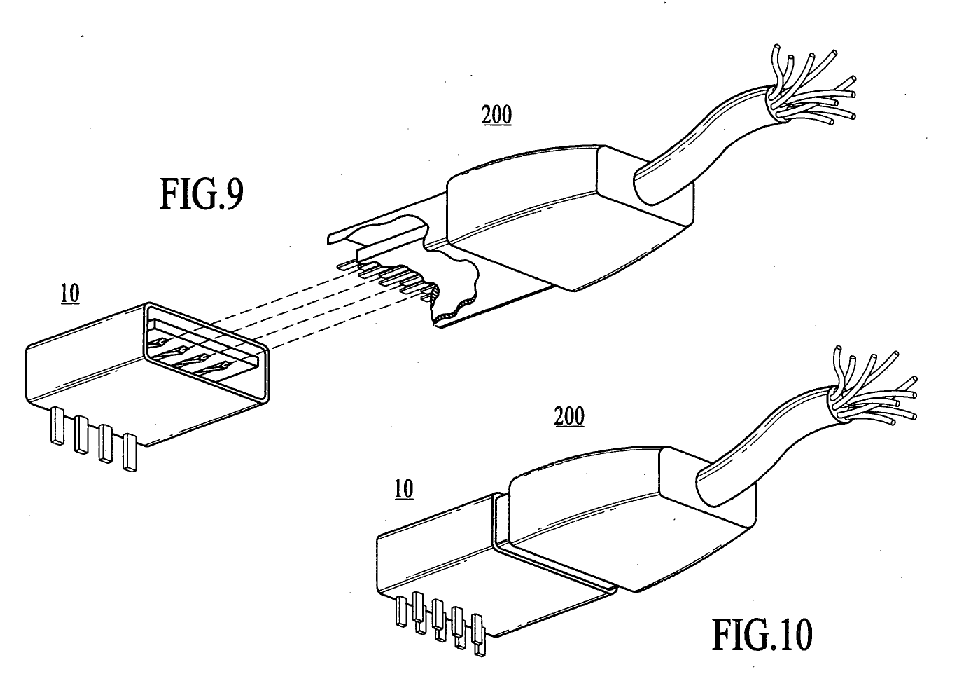

FIG. 9 illustrates the conventional USB female connector 10 of FIG. 1 and the male connector 200 of FIG. 6 before mating. FIG. 10 illustrates the female connector 10 of FIG. 1 and the male connector 200 of FIG. 6 after mating. These figures illustrate that the male connector 200 in accordance with the present invention can also be engaged with the conventional female connector 10.

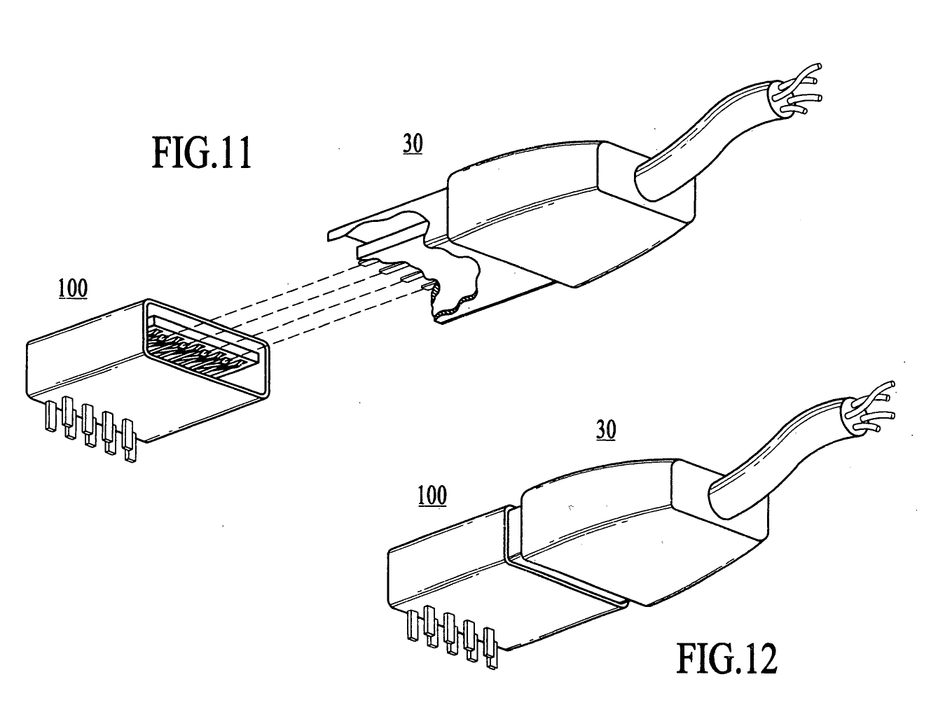

FIG. 11 illustrates the conventional USB male connector 30 of FIG. 2 and the female connector 100 of FIG. 5 before mating. FIG. 12 illustrates the male connector 30 of FIG. 2 and the female connector 100 of FIG. 5 after mating. Similarly, these figures illustrate that the female connector 100 in accordance with the present invention can also be engaged with the conventional male connector 30.

Accordingly, what is provided is a connector which has additional functionality which incorporates conventional standard functionality of a USB connector while also including the additional functionality which incorporates the additional pins within that connector. In so doing, a system is provided which is more versatile and can be utilized in a more robust way than previous connector systems. In addition, either connector can be used with a standard interface. It is compatible with existing systems. One should readily recognize that although the present invention has been described in conjunction with the USB interface, this system could be used within a variety of environments and they would be within the spirit and scope of the present invention. Although the standard USB interface is utilized as example, one of ordinary skill in the art readily recognizes that a variety of other interface standards which may be present now or which may come in the future could be utilized in such a system, including for example, USB 2.0, mini USB, IEEE 1394, etc.

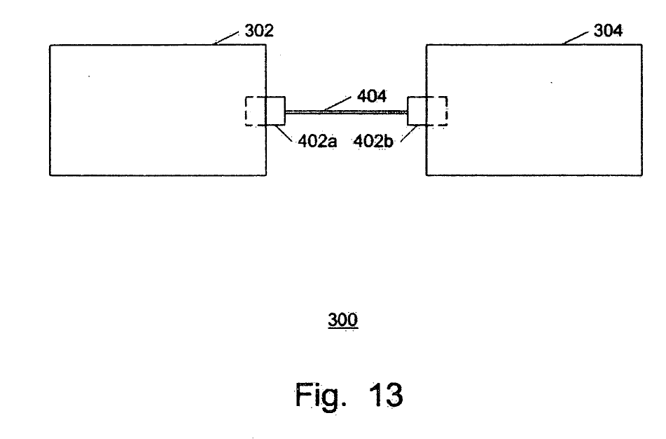

It will be clear that the invention described herein provides significant functional enhancements when incorporated into prior art systems. FIG. 13 shows an exemplary system 300 using the connector described herein. The system includes at least two devices 302 and 304 to be connected together. Each device 302 and 304 contains an enhanced USB connector interface 402a and 402b as described herein. They can be connected together via cable 404 (which is modified to contain extra wires to match extra pins in the enhanced connector). Alternatively, one of the devices can be itself constructed integrally with the USB connector so that it can be docked in place when mated with the other device, for example, as is done with flash-backed memory sticks, or similar devices that include an integral USB connector. When connected together, the devices can exchange data via the enhanced connector signals that would not be conveniently possible but for the existence of the additional functional signals.

For example, one device (a media player) can provide video or n-channel audio data to another device (a television or speaker set) without requiring extra cables. This could be especially useful in devices that are too small or inexpensive to have dedicated IO lines for video or audio data. Again using the example of a device with integral USB interface, such a device could be configured as a media player to be mated with a speaker housing that receives both the audio output data and any additional menu or control data via the same enhanced USB interface.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A connector comprising:
a plurality of universal serial bus (USB) pins; and
a plurality of pins for additional functionality, wherein the connector can engage a conventional USB connector or a connector that also utilizes the plurality of pins.

2. The connector of claim 1 wherein the plurality of USB pins comprises a reference voltage pin, a ground pin and two data pins.

3. The connector of claim 1 wherein the plurality of pins comprises:
an audio left pin; an audio right pin; and an audio return pin.

4. The connector of claim 3 wherein the plurality of pins further comprises a serial data in pin and a serial data out pin.

5. The connector of claim 3 wherein the connector comprises a female connector.

6. The connector of claim 5 wherein the plurality of pins and the plurality of USB pins are spring-loaded.

7. A connector comprising:
four universal serial bus (USB) pins, wherein the four USB pins comprise a reference voltage pin, a ground pin and two data pins; and
five pins for additional functionality; the five pins comprising a serial data in pin; a serial data out pin; an audio left pin; an audio right pin; and an audio return pin, wherein the connector can engage with a conventional USB connector or a connector that also utilizes the five pins.

8. The connector of claim 7 wherein the connector comprises a male connector.

9. The connector of claim 7 wherein the connector comprises a female conductor.

10. The connector of claim 7 wherein the four USB pins and five pins for additional functionality are spring-loaded.

11. A female connector comprising:
a plurality of spring-loaded universal serial bus (USB) pins; and
at least one spring-loaded pin for additional functionality, wherein the female connector can engage a conventional male USB connector, or a male connector that also utilizes the at least one pin.

12. The connector of claim 11 wherein the plurality of USB pins comprises a power pin, a ground pin and two data pins.

13. The connector of claim 11 wherein the at least one spring-loaded pin is selected from one of the following: an audio signal pin, a video signal pin, a serial data pin.

14. A male connector comprising:
a circuit board including a plurality of universal serial bus circuit traces; and a at least one trace for additional functionality, wherein the male connector can engage a conventional female USB connector, or a female connector that also utilizes the at least one trace.

15. The female connector of claim 14 wherein the plurality of USB circuit traces comprises a power trace, a ground trace and two data traces.

16. The male connector of claim 14 wherein the plurality of pins comprises:
a serial data in trace; a serial data out trace; an audio left trace; an audio right trace; and an audio ground trace.

17. A female connector comprising:
four universal serial bus (USB) pins, wherein the four USB pins comprise a reference voltage pin, a ground pin and two data pins; and
five pins for additional functionality; the five pins comprising a serial data in pin; a serial data out pin; an audio left pin; an audio right pin; and an audio return pin, wherein the connector can engage with a conventional male USB connector or a male connector that also utilizes the five pins.

18. A male connector comprising:
a circuit board including four universal serial bus (USB) circuit traces, wherein the four USB traces comprise a power trace, a ground trace and two data traces; and
five traces for additional functionality; the five traces comprising a serial data in trace; a serial data out trace; an audio left trace; an audio right trace; and an audio return pin, wherein the connector can engage with a conventional USB female connector or a connector that also utilizes the five traces.

19. A connector comprising:
a plurality of standard interface pins; and
a plurality of pins for additional functionality, wherein the connector can engage a conventional connector in accordance with the standard interface or a connector that utilizes the plurality of pins.

20. The connector of claim 19 wherein the standard interface comprises the universal serial bus interface.

21. A female connector comprising:
a housing;
a plate coupled to the housing;
a plurality of springloaded universal serial bus (USB) pins coupled to the plate; and
a plurality of springloaded pins for additional functionality, the plurality of pins being placed in between the plurality of USB pins such that the USB pins can engage a conventional USB connector and such that the connector can engage with a connector that utilizes the plurality of pins to allow for the use of a connector with additional functionality.

22. A female connector comprising:
a housing;
a plate coupled to the housing;
four springloaded universal serial bus (USB) pins coupled to the plate, wherein the four USB pins comprise a power pin, a ground pin and two data pins; and
five springloaded pins for additional functionality, the five pins comprising a serial data in pin; a serial data out pin; an audio left pin; an audio right pin; and an audio ground pin, the five springloaded pins being placed in between the four USB pins such that the four USB pins can engage a conventional USB connector and such that the connector can engage a connector that utilizes the five springloaded pins to allow for use with a connector with additional functionality.

23. A male connector comprising:
a housing;
a circuit board coupled to the housing;
a plurality of universal serial bus (USB) circuit traces coupled to the circuit board;
a plurality of circuit traces for additional functionality, the plurality of circuit traces being placed in between the plurality of USB circuit traces such that the USB circuit traces can engage a conventional USB connector and such that the connector can engage a connector that utilizes the plurality of circuit traces to allow for the use with a connector with additional functionality.

24. A male connector comprising:
a housing;
a circuit board coupled to the housing;
four universal serial bus (USB) circuit traces coupled to the circuit board, and five circuit traces coupled to the circuit board for additional functionality, wherein the four USB traces comprise a power trace, a ground trace and two data traces; and wherein the five traces comprising a serial data in trace; a serial data out trace; an audio left trace; an audio right trace; and an audio ground trace, the five circuit traces being placed in between the four USB circuit traces such that the four USB circuit traces can engage a conventional USB connector and such that the connector can engage a connector that utilizes the five circuit traces to allow for use with a connector with additional functionality.

25. A female connector comprising:
a housing;
a plate coupled to the housing;
four springloaded universal serial bus (USB) pins coupled to the plate; and five springloaded pins for additional functionality, wherein the four USB pins and the five pins for additional functionality are in the following configuration: pin 1 comprises a 5 V USB reference signal pin; pin 2 comprises a Data−USB pin; pin 3 comprises a Data+USB pin; pin 4 comprises a USB ground pin; pin 5 comprises a serial data to device pin; pin 6 comprises a serial data from device pin; pin 7 comprises an audio common pin; pin 8 comprises an audio left pin; and pin 9 comprises an audio right pin.

26. A male connector comprising:
a housing;
a circuit board coupled to the housing;
four universal serial bus traces; and
five circuit traces for additional functionality, wherein the four USB traces and the five traces for additional functionality are in the following configuration: trace 1 comprises a 5 V USB reference signal trace; trace 2 comprises a Data−USB trace; trace 3 comprises a Data+USB trace; trace 4 comprises a USB ground trace; trace 5 comprises a serial data to device trace; trace 6 comprises a serial data from device trace; trace 7 comprises an audio common trace; trace 8 comprises an audio left trace; and trace 9 comprises an audio right trace.

27. A cable system comprising:
a cable including a plurality of USB wires and extra wires for additional functionality; and
two connectors which are coupled to each end of the cable, each of the two connectors comprising a plurality of universal serial bus (USB) pins; and a plurality of pins for additional functionality, wherein each of the connectors can engage a conventional USB connector or a connector that also utilizes the plurality of pins.

28. A system comprising:
a first device;
a second device; and
a connector system for coupling the first device to the second device, the connector system including at least one female connector and at least one male connector, wherein the at least one male connector comprises a housing; a circuit board coupled to the housing; a plurality of universal serial bus (USB) circuit traces coupled to the circuit board; a plurality of circuit traces for additional functionality, the plurality of circuit traces being placed in between the plurality of USB circuit traces such that the USB circuit traces can engage a conventional USB connector and such that the connector can engage a connector that utilizes the plurality of circuit traces to allow for the use with a connector with additional functionality; and the at least one female connector comprises a housing; a plate coupled to the housing; a plurality of springloaded universal serial bus (USB) pins coupled to the plate; and a plurality of springloaded pins for additional functionality, the plurality of pins being placed in between the plurality of USB pins such that the USB pins can engage a conventional USB connector and such that the connector can engage with a connector that utilizes the plurality of pins to allow for the use of a connector with additional functionality.

29. An apparatus comprising:
a device; and
a connector coupled to the device, the connector comprising a plurality of spring-loaded universal serial bus (USB) pins; and at least one spring-loaded pin for additional functionality, wherein the female connector can engage a conventional male USB connector, or a male connector that also utilizes the at least one pin.

30. The apparatus of claim 29 wherein the devices comprise any of a speaker set, remote control device; and a display device.

31. An apparatus comprising:
a device; and
a connector coupled to the device, the connector comprising four universal serial bus (USB) pins, wherein the four USB pins comprise a reference voltage pin, a ground pin and two data pins; and five pins for additional functionality; the five pins comprising a serial data in pin; a serial data out pin; an audio left pin; an audio right pin; and an audio return pin, wherein the connector can engage with a conventional male USB connector or a male connector that also utilizes the five pins.

32. The apparatus of claim 31 wherein the devices comprise any of a speaker set, remote control device; and a display device.

33. An apparatus comprising:
a device; and
a connector coupled to the device, the connector comprising a plate coupled to the housing; a plurality of springloaded universal serial bus (USB) pins coupled to the plate; and a plurality of springloaded pins for additional functionality, the plurality of pins being placed in between the plurality of USB pins such that the USB pins can engage a conventional USB connector and such that the connector can engage with a connector that utilizes the plurality of pins to allow for the use of a connector with additional functionality.

34. The apparatus of claim 33 wherein the devices comprise any of a speaker set, remote control device; and a display device.

35. An apparatus comprising:
a device; and
a connector coupled to the device, the connector comprising a housing; a plate coupled to the housing; four springloaded universal serial bus (USB) pins coupled to the plate, wherein the four USB pins comprise a power pin, a ground pin and two data pins; and
five springloaded pins for additional functionality, the five pins comprising a serial data in pin; a serial data out pin; an audio left pin; an audio right pin; and an audio ground pin, the five springloaded pins being placed in between the four USB pins such that the four USB pins can engage a conventional USB connector and such that the connector can engage a connector that utilizes the five springloaded pins to allow for use with a connector with additional functionality.

36. The apparatus of claim 35 wherein the devices comprise any of a speaker set, remote control device; and a display device.

37. An apparatus comprising:
a device; and
a connector coupled to the device, the connector comprising a plate coupled to the housing; four springloaded universal serial bus (USB) pins coupled to the plate; and five springloaded pins for additional functionality, wherein the four USB pins and the five pins for additional functionality are in the following configuration: pin 1 comprises a 5 V USB reference signal pin; pin 2 comprises a Data−USB pin; pin 3 comprises a Data+USB pin; pin 4 comprises a USB ground pin; pin 5 comprises a serial data to device pin; pin 6 comprises a serial data from device pin; pin 7 comprises an audio common pin; pin 8 comprises an audio left pin; and pin 9 comprises an audio right pin.

38. The apparatus of claim 37 wherein the devices comprise any of a speaker set, remote control device; and a display device.
